(19) United States
(12) Patent Application Publication
(10) Pub. No.: US 2021/0291303 A1
(43) Pub. Date: Sep. 23, 2021

(54) INSPECTION DEVICE AND WELDING DEVICE

(71) Applicant: KABUSHIKI KAISHA TOSHIBA, Tokyo (JP)

(72) Inventors: Chinatsu MORI, Yokohama (JP); Hidenori SATO, Yokohama (JP); Takashi OBARA, Yokohama (JP)

(73) Assignee: KABUSHIKI KAISHA TOSHIBA, Tokyo (JP)

(21) Appl. No.: 17/164,907

(22) Filed: Feb. 2, 2021

(30) Foreign Application Priority Data
Mar. 23, 2020 (JP) 2020-050801

(51) Int. Cl. B23K 31/12; B23K 9/095; G06K 9/62

(52) U.S. Cl. CPC B23K 31/125; G06K 9/6202; B23K 9/095

(57) ABSTRACT

An inspection device includes an imager and a processor. The imager acquires first image data and second image data. The first image data is of a first weld zone imaged using a first condition. The first weld zone includes a first non-weld area, a second non-weld area, and a first weld area between the first non-weld area and the second non-weld area. The second image data is of the first weld zone imaged using a second condition. The processor performs a first inspection. The first inspection is based on a result of detecting a first boundary and a result of detecting a second boundary. The first boundary is between the first non-weld area and the first weld area based on the first image data. The second boundary is between the first weld area and the second non-weld area based on the second image data.

### CROSS-REFERENCE TO RELATED APPLICATIONS

This application is based upon and claims the benefit of priority from the prior Japanese Patent Application No. 2020-050801, filed on Mar. 23, 2020; the entire contents of which are incorporated herein by reference.

### FIELD

Embodiments relate to an inspection device and a welding device.

### BACKGROUND

Welding is performed using a laser or the like. It is desirable to more appropriately inspect the weld state. For example, a more appropriate weld is obtained by appropriately inspecting the weld state.

### BRIEF DESCRIPTION OF THE DRAWINGS

FIG. 1 is a schematic view illustrating a configuration of an inspection device according to a first embodiment;

FIGS. 2A and 2B are schematic plan views illustrating an inspection object to be inspected in the inspection device according to the first embodiment;

FIGS. 3 to 6 are schematic drawings illustrating an operation of the inspection device according to the first embodiment;

FIG. 7 is an explanatory drawing of a detection of existence of holes or cracks of the weld area;

FIG. 8 is an explanatory drawing of a detection of existence of misalignment;

FIG. 9 is a flowchart illustrating operation of inspection processing of the inspection device according to the first embodiment;

FIG. 10 is a flowchart illustrating details of the operation of the inspection processing of the inspection device according to the first embodiment;

FIG. 11 is a schematic view illustrating a hardware configuration of the inspection device according to the first embodiment;

FIG. 12 is a schematic view illustrating a welding device according to a second embodiment; and

FIG. 13 is a graph showing a calibration curve of an example of the relationship between the weld width and laser output of the welding device.

### DETAILED DESCRIPTION

An inspection device according to an embodiment includes an imager and a processor. The imager acquires first image data and second image data. The first image data is of a first weld zone imaged using a first condition. The second image data is of the first weld zone imaged using a second condition different from the first condition. The first weld zone includes a first non-weld area, a second non-weld area, and a first weld area between the first non-weld area and the second non-weld area. The processor performs at least a first inspection of the first weld zone. The first inspection is based on a result of detecting a first boundary and a result of detecting a second boundary. The first boundary is between the first non-weld area and the first weld area based on the first image data. The second boundary is between the first weld area and the second non-weld area based on the second image data.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions. In the specification and drawings, components similar to those described previously or illustrated in an antecedent drawing are marked with like reference numerals, and a detailed description is omitted as appropriate.

### First Embodiment

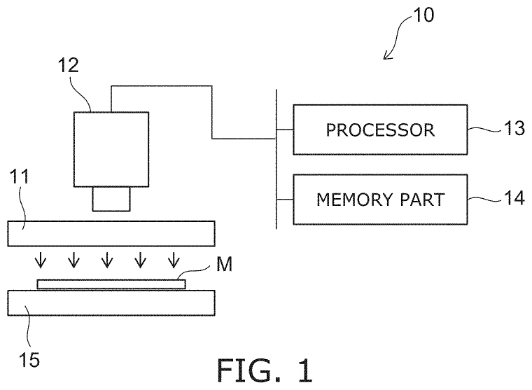

FIG. 1 is a schematic view illustrating the configuration of an inspection device according to an embodiment. The inspection device according to the embodiment inspects, one spot at a time, multiple weld zones that are included in an inspection object.

As shown in FIG. 1, the inspection device 10 includes an illuminator 11, an imager 12, a processor 13, and a memory part 14.

The illuminator 11 irradiates light on a weld zone of an inspection object M placed on a stage 15 so that a clearer image is obtained by the imager 12. For example, multi-angle ring lighting may be used as the illuminator 11.

The imager 12 images, one at a time, multiple weld zones that are included in the inspection object M placed on the stage 15. The imager 12 includes, for example, a camera such as a CCD image sensor, a CMOS image sensor, etc. The imager 12 includes an imaging controller. The imaging controller sets the imaging conditions of the camera and controls the camera.

The imager 12 images the weld zone illuminated with the light from the illuminator at least two times using different imaging conditions. Thereby, for one weld zone, data of at least two images (first image data and second image data) that are imaged using different imaging conditions (a first condition and a second condition) are obtained. These image data are stored in the memory part 14. The imaging condition includes the exposure time when imaging by the imager, the illuminance of the weld zone, etc. Details of the setting of the imaging condition are described below.

The processor 13 detects weld marks as weld areas in the weld zones from the data of at least two images that are imaged by the imager 12. The processor 13 inspects the weld zone based on the image data of the weld area. That is, the processor 13 detects the weld area in the weld zone by detecting a boundary between the weld area and the non-weld area.

The processor 13 calculates the luminance values of the pixels included in the image for the data of at least two images that are imaged by the imager 12. In each image, the pixels (the edge) that have a large luminance change are detected as the boundary between the weld area and the non-weld area.

Thus, the processor 13 detects the first boundary based on the first image data, and detects the second boundary based on the second image data. Thereby, the weld area is detected from the first and second image data.

The processor 13 inspects the goodness of the weld zone based on the luminances of the pixels corresponding to the weld area in the image data. The inspection of the weld zone includes, for example, an evaluation related to whether or not the weld width is appropriate, and an evaluation related to the existence of a hole, a crack, misalignment, or lifting.

Details of the content of the inspection and the image processing such as weld area detection, etc., by the processor 13 are described below.

The memory part 14 stores parameters used when the processor 13 inspects. The memory part 14 stores the images that are imaged by the imager 12, the inspection result of the processor 13, etc.

### Imaging Conditions

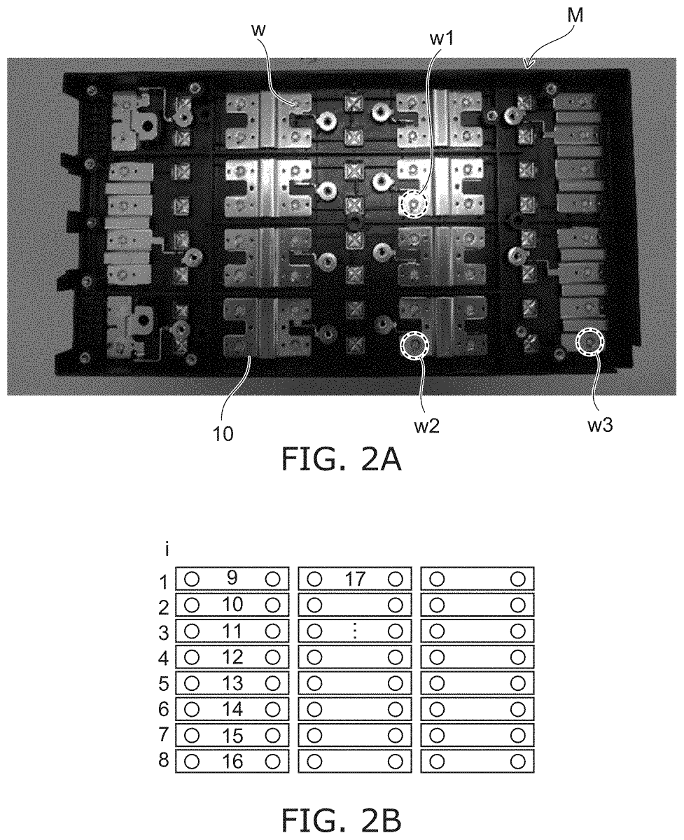

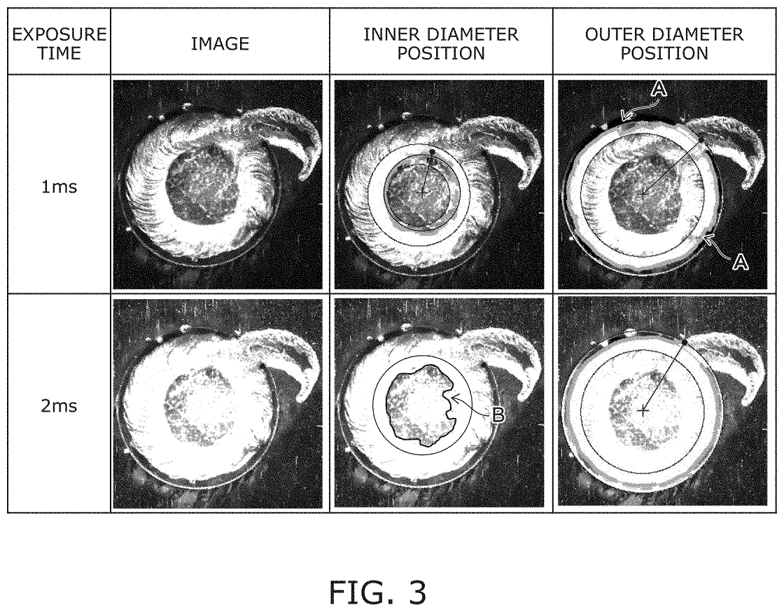

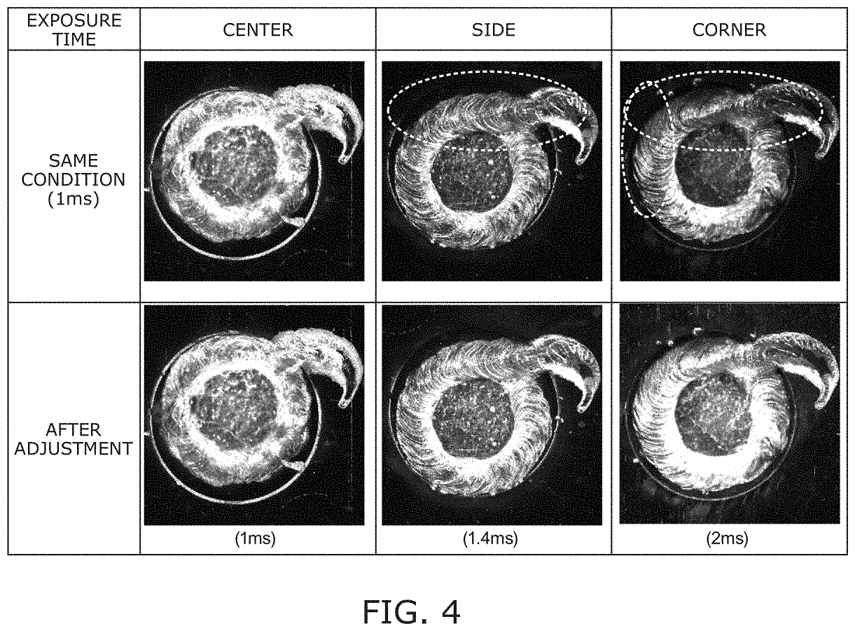

FIGS. 2A and 2B are schematic plan views of an electric module showing an example of an inspection object inspected in the inspection device according to the embodiment. FIGS. 3 and 4 illustrate images of one weld zone included in the electric module of FIGS. 2A and 2B that is imaged by the imager of the inspection device according to the embodiment.

As shown in FIGS. 2A and 2B, the electric module that is the inspection object M includes weld zones at multiple spots (in the example of FIGS. 2A and 2B, 48 spots). As shown in FIGS. 3 and 4, each weld zone of the electric module is ring-shaped. As an example according to the embodiment, the imaging conditions when the electric module shown in FIGS. 2A and 2B is inspected as the inspection object M will now be described. As shown in FIG. 2B, numerals i are preassigned to the multiple welding spots of the inspection object M. In the inspection by the inspection device 10, the imaged images, the imaging conditions, the evaluation results, the measured values, etc., are stored in the memory part 14 by being associated with the numerals i of the welding spots.

The imager 12 images one weld zone at least two times by using different imaging conditions (the first and second conditions) and acquires data of at least two images (the first and second image data). As an example of the imaging conditions according to the embodiment, the imager 12 images multiple times using different exposure times.

FIG. 3 shows an example in which two images are acquired using different exposure times. Specifically, the upper level of FIG. 3 is an example of the imaged image (the first image data) in which the exposure time is 1 ms (the first condition); and the lower level is an example of the imaged image (the second image data) in which the exposure time is 2 ms (the second condition).

In the example of FIG. 3, the weld area is ring-shaped; and luminance differences that are caused by the imaging conditions (the exposure times) of the images occur in the area (a first non-weld area) at the inner side of the ring and the area (a second non-weld area) at the outer side of the ring because a fine unevenness exists in the weld area. Therefore, the image that is favorable when measuring the inner contour line (the inner diameter) of the weld area and the image that is favorable when measuring the outer contour line (the outer diameter) of the weld area are different.

As shown in FIG. 3, for example, the image that is imaged using 1 ms is suited to measuring the inner contour line (the inner diameter) of the weld area because the luminance difference is large and the boundary is relatively distinct between the weld area and the first non-weld area that is at the inner side of the weld area (inward of the ring) (FIG. 3). On the other hand, the image that is imaged using 1 ms is not suited to measuring the outer contour line (the outer diameter) of the weld area because a blurred portion exists at the boundary between the weld area and the second non-weld area that is at the outer side of the weld area (outward of the ring) (arrow A in FIG. 3).

The image that is imaged using 2 ms is suited to measuring the outer contour line (the outer diameter) of the weld area because the luminance value difference is large and the boundary is relatively distinct between the weld area and the second non-weld area that is at the outer side of the weld area (outward of the ring). On the other hand, the image that is imaged using 2 ms includes a portion at which the boundary is indistinct and the luminance at the inner side of the weld area (inward of the ring) is about equal to that of the weld area (arrow B in FIG. 3). Accordingly, the image that is imaged using 2 ms is not suited to measuring the inner contour line (the inner diameter) of the weld area.

Thus, the inner and outer diameters of the weld area can be accurately measured by using multiple images that are imaged using different exposure times. The weld area can be accurately detected thereby. When using different imaging conditions, for example, the imager 12 may image multiple images by using different illuminances of the light irradiated from the illuminator 11.

An inspection device 1 images the weld zone one spot at a time and inspects the weld zone one spot at a time by placing the electric module on the stage 15 of FIG. 1 and by moving the stage. As shown in FIGS. 2A and 2B, wall-shaped members are provided at the four sides of the electric module. Therefore, compared to the image of a weld zone w1 that is at the central portion of the electric module, the images of a weld zone w2 that is at a side and a weld zone w3 that is at a corner are darker if the same imaging condition is used.

The upper level of FIG. 4 shows images of the electric module imaged using an exposure time of 1 ms. The upper level of FIG. 4 shows the image of the weld zone w1 at the central portion of the electric module, the image of the weld zone w2 at the side, and the image of the weld zone w3 at the corner in this order from the left. Compared to the image of the weld zone w1 at the central portion as shown in FIG. 4, the luminance values are low and the image is dark over the entirety for the image of the weld zone w2 at the side and the image of the weld zone w3 at the corner.

Accordingly, it is favorable for the imager 12 to image while change the imaging condition according to the position of the weld zone in the inspection object M. An image that is better suited to detecting the weld area can be acquired thereby.

The lower level of FIG. 4 shows an example of images that are imaged by changing the exposure time according to the position of the weld zone. The left end of the lower level of FIG. 4 shows an example of an image in which the weld zone w1 at the central portion is imaged using an exposure time of 1 ms. The center of the lower level of FIG. 4 shows an example of an image of the weld zone w2 at the side imaged using an exposure time of 1.4 ms. The right end of the lower level of FIG. 4 shows an example of an image of the weld zone w3 at the corner imaged using an exposure time of 2 ms.

Thus, the imager 12 switches the imaging conditions according to the position of the weld zone in the inspection object and acquires data of at least two images by imaging the weld zone to be imaged multiple times using different imaging conditions. An image for detecting the weld area with high accuracy can be obtained thereby.

### Inspection by Processor

Continuing, inspection processing of the processor 13 will now be described.

The inspection of the weld zone that is performed by the processor 13 includes, for example, an inspection related to whether or not the welding is performed or whether or not the weld width is appropriate and an inspection related to the existence of a hole, a crack, misalignment, or lifting. The inspections will now be described.
(1) Inspection Related to Unwelded Defect

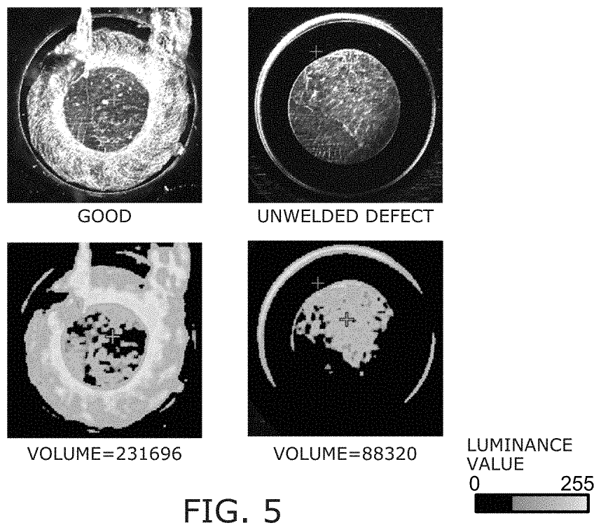

FIG. 5 is an explanatory drawing of an inspection of whether or not the weld zone is welded.

The processor 13 determines data of one image used to inspect whether or not the weld zone is welded from the data of multiple images that are imaged by the imager 12. Here, for example, the first image data that is imaged using a short exposure time is used. The processor 13 sets an initial circle in the first image data so that the weld zone to be measured is included. The processor 13 calculates the luminance values of the pixels included in the initial circle set in the first image data and calculates the surface area or the volume (surface areaxaverage luminance value) of high-luminance areas having luminance values that are not less than a threshold.

The processor 13 evaluates the weld zone to be welded when the surface area or volume of the high-luminance areas is greater than a prescribed value. On the other hand, the weld zone is evaluated to be unwelded when the surface area or volume of the high-luminance areas is less than the prescribed value. A spot that is unwelded is evaluated to be a spot that needs to be welded. The evaluation results are stored in the memory part 14.
(2) Inspection Related to Weld Area Width (Narrow/Lifting)

The processor 13 calculates the luminance values of the pixels included in the image for two images that are imaged by the imager 12. When the weld area is ring-shaped as described above, an image (a first image) of the two images that is imaged using a relatively short exposure time is used to measure the inner diameter of the weld area. An image (a second image) that is imaged using a relatively long exposure time is used to measure the outer diameter of the weld area.

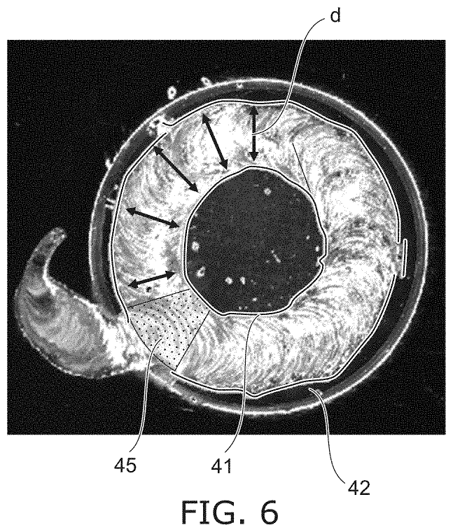

FIG. 6 is an explanatory drawing of a measurement of the widths of an inner diameter contour line 41 and an outer diameter contour line 42 of the weld area. The processor 13 calculates the center of the weld area and sets an initial circle on the weld area using the center. The processor 13 estimates the edges of the weld area by searching for the pixels (the edges) along radial directions from the center of the initial circle that have large luminance value changes. More specifically, the inner diameter contour line 41 and the outer diameter contour line 42 of the weld area are estimated from the

Euclidean distances from the center coordinates of the initial circle to the coordinates of the edges of the weld area. Thus, the processor 13 detects the weld area.

The processor 13 calculates, as the width (the weld width) at each angle, the difference value between the outer diameter contour line 42 and the inner diameter contour line 41 every 0.5 degrees referenced to the center of the initial circle. The processor 13 calculates the average value of the difference values at the angles for the outer diameter contour line 42 and the inner diameter contour line 41 at a total of 720 spots around the entire circumference, and stores the average value in the memory part 14 as a width d of the weld area.

The processor 13 evaluates the width d of the weld area to be appropriate when the calculated width d of the weld area is within a predetermined range of values. When the width d of the weld area is a value outside the predetermined range, the width d of the weld area is evaluated to be inappropriate. The evaluation results are stored in the memory part 14. The measured width d of the weld area is stored in the memory part 14 by being associated with the numerals i of the welding spots regardless of being appropriate or inappropriate.

When the width d of the weld area is inappropriate, the processor 13 performs an evaluation of whether the weld area is too narrow or too wide.

The processor 13 evaluates whether the weld area is too narrow or too wide by determining whether or not the maximum and minimum values of the calculation weld widths at each angle of the 720 spots are within the prescribed range. Specifically, the processor 13 evaluates the weld area to be too narrow when one of the maximum value or the minimum value is less than the values of the prescribed range and evaluates that the weld area is too wide when one of the maximum value or the minimum value is greater than the values of the prescribed range.

When the weld area is too narrow, it is evaluated that rewelding is necessary. On the other hand, when the weld area is too wide, it is evaluated that a visual check by a worker is necessary.

The processor 13 also can evaluate whether or not the width d of the weld area is appropriate, too narrow, too wide, etc., by using the average value, the maximum value, and the minimum value of the distances of the points from the center of the initial circle to the inner diameter contour line 41 or the outer diameter contour line 42.

When calculating the weld width at each angle, the processor 13 may set a portion of the 720 spots to be a nonrelevant measurement area for the weld width. As shown in FIG. 6, there are cases where the inner diameter contour line 41 or the outer diameter contour line 42 cannot be accurately measured when a weld area that juts from the ring-shaped weld area exists. Therefore, as shown in FIG. 6, a nonrelevant measurement area 45 may be determined, and the processor may not calculate the weld width in the nonrelevant measurement area 45.

In the inspection related to narrowness described above, the processor 13 inspects whether or not lifting of the weld zone has occurred for the weld zone evaluated to be too narrow.

The processor 13 determines data of one image to be used to inspect the existence of lifting from the data of multiple images of the imager 12. Here, for example, the first image data that is imaged using the short exposure time is used. The processor 13 sets the initial circle in the first image data to include the weld zone to be measured. The processor 13 calculates the luminance values of the pixels included in the initial circle set in the first image data and calculates the surface area of low-luminance areas having luminance values not more than a threshold. The weld zone is evaluated to have lifting when the surface area of the low-luminance areas is greater than a prescribed value.
(3) Inspection Related to Existence of Holes/Cracks

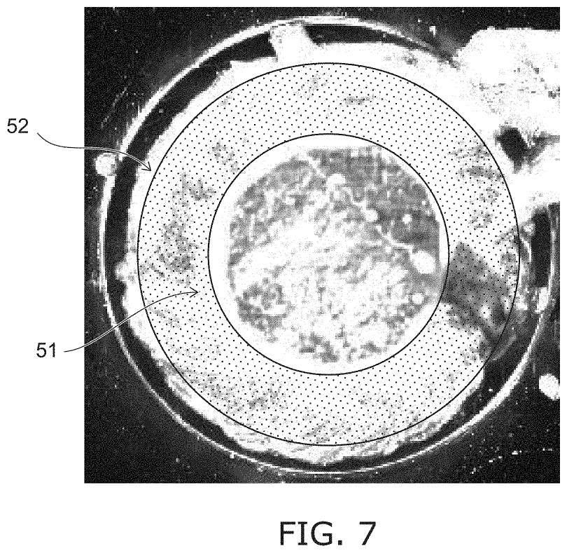

FIG. 7 is an explanatory drawing of a detection of the existence of holes or cracks of the weld area.

The processor 13 draws an average radius circle 51 of the inner diameter contour and an average radius circle 52 of the outer diameter contour based on the inner diameter contour line 41 and the outer diameter contour line 42 of the weld area measured when calculating the width d of the weld area. At this time, the average radius circle 51 of the inner diameter contour is a circle drawn with a radius of a predetermined constant A added to the average radius of the inner diameter contour line 41. The average radius circle 52 of the outer diameter contour is a circle drawn with a radius of a predetermined constant B added to the average radius of the outer diameter contour line 42. Both the average radius circle 51 of the inner diameter contour and the average radius circle 52 of the outer diameter contour are drawn with the centroid coordinate of the outer diameter contour line 42 as the center.

The processor 13 calculates the luminance values of the pixels included in the ring-shaped area between the average radius circle 51 of the inner diameter contour and the average radius circle 52 of the outer diameter contour and calculates the surface area of the partial areas of low luminances having luminance values that are not more than a threshold. When the surface area of the partial area is greater than the prescribed threshold, this partial area is detected to be a hole, depression, or crack. When a hole, depression, or crack exists, it is evaluated that rewelding is necessary. The evaluation results are stored in the memory part 14.
(4) Inspection Related to Existence of Misalignment

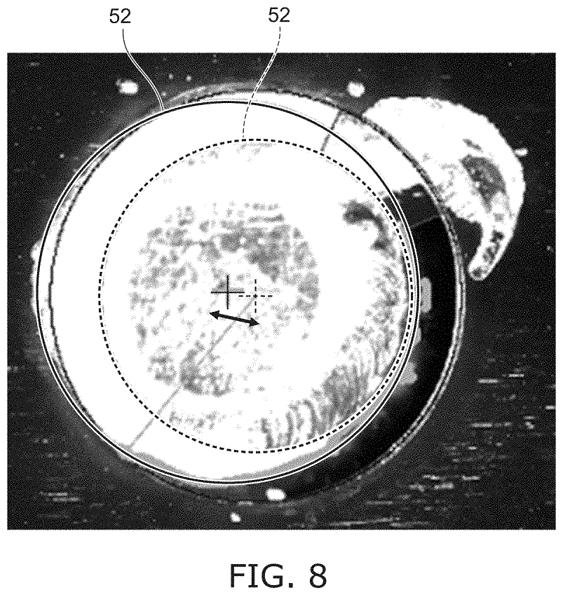

FIG. 8 is an explanatory drawing of a detection of the existence of misalignment.

The processor 13 uses the centroid of the outer diameter contour line 42 as the centroid position of the weld area and measures the misalignment with respect to the ideal centroid position. The centroid position of the outer diameter contour line of a preregistered reference image of a good part is used as the ideal centroid position. When the Euclidean distance between the two centroid positions is not less than a prescribed value, the processor 13 evaluates the position of the weld area to be misaligned; and the processor 13 stores the evaluation results in the memory part 14.

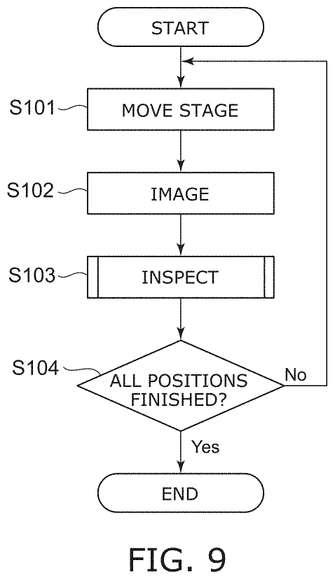

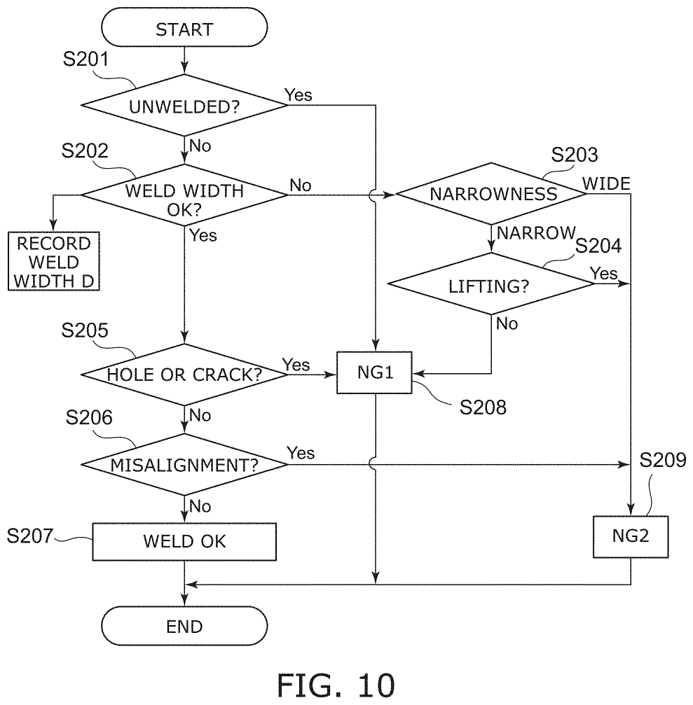

The inspection processing of an inspection device having such a configuration will now be described using the flowcharts of FIGS. 9 and 10.

FIG. 9 is a flowchart illustrating the operation of inspection processing of the inspection device according to the embodiment. FIG. 10 is a flowchart illustrating details of the operation of the inspection processing of the inspection device according to the embodiment.

As shown in FIG. 9, when the inspection object M is placed on the stage 15 of the inspection device 10, the inspection of the multiple welding spots included in the inspection object M is started one spot at a time. In step S101, the processor 13 moves the stage 15 so that the weld zone to be inspected is included in the field of view of the imager 12.

In step S102, for example, the illuminator 11 irradiates light so that the weld area of the weld zone is bright and the other portions are dark in the image. The imager 12 acquires at least two images of the weld zone to be inspected by using different imaging conditions. Specifically, the imager 12 acquires the first image in which the weld zone is imaged using a first imaging condition (e.g., the exposure time being 1 ms) and the second image in which the weld zone is imaged using a second imaging condition (e.g., the exposure time being 2 ms).

In step S103, the processor 13 inspects the weld zone by using the two images that are imaged by the imager 12. The detailed operations of the inspection processing are described below.

When the inspection of the weld zone is finished, the processor 13 determines whether or not the inspection is finished for all of the welding spots (all of the positions) included in the inspection object M in step S104; the processing described above is repeated until the inspection is finished for all of the welding spots. The inspection processing ends when the inspection is finished for all of the welding spots.

As shown in FIG. 6, the processor 13 inspects using the first and second image data imaged by the imager 12. In the inspection, the state of the welding spot is classified as three types, i.e., “weld OK”, “NG1”, and “NG2”. Specifically, “weld OK” means that the weld state is appropriate. “NG1” means that the weld state is inappropriate and the welding processing should be performed again for this spot. “NG2” means that the weld state is inappropriate; and a check by a worker is necessary for this spot.

The processor 13 performs the inspection processing according to the flowchart shown in FIG. 10. First, as shown in

FIG. 10, the processor 13 inspects whether or not the weld zone to be inspected is unwelded (step S201). When the inspection evaluates that the weld zone is unwelded, the flow proceeds to NG1 of step S208; the evaluation results are stored in the memory part 14; and the inspection of the weld zone ends. When the weld zone is evaluated to be welded, the flow proceeds to the next step S202.

In step S202, the weld area is detected from the weld zone; the width of the detected weld area is measured; and it is evaluated whether or not the width of the weld area is appropriate. When the width of the weld area is inappropriate, the flow proceeds to step S203; when the width of the weld area is appropriate, the flow proceeds to step S205. The results are stored in the memory part 14 regardless of whether the width of the weld area is appropriate or inappropriate.

Whether the width is narrow or wide with respect to the appropriate width of the weld area is evaluated in step S203. When the width of the weld area is too narrow, the flow proceeds to step S204. When the width of the weld area is too wide, the flow proceeds to NG2 of step S209. In step S204, the processor 13 inspects whether or not there is lifting of the weld area. When there is lifting of the weld area, the processor 13 proceeds to NG2 of step S209; when there is no lifting of the weld area, the processor 13 proceeds to NG1 of step S208. In any case, the processor 13 stores the evaluation results of the weld area in the memory part 14 and ends the inspection of the weld area.

In step S205, the processor 13 inspects a hole or crack in the weld area. When a hole, crack, or the like exists in the weld area, the processor 13 proceeds to NG1 of step S208 and ends the inspection of the weld area. When there is no hole, crack, etc., in the weld area, the processor 13 proceeds to step S206.

In step S206, the processor 13 inspects whether or not there is misalignment of the weld area. When there is misalignment of the weld area, the processor 13 proceeds to NG2 of step S209 and ends the inspection of the weld area. When there is no misalignment of the weld area, the processor 13 proceeds to step S207.

In step S207, the weld zone to be inspected is evaluated to be appropriate in all of the inspections of steps S201 to S206 by the processor 13. Accordingly, the processor 13 stores, in the memory part 14, the evaluation result of “weld OK” for the weld zone and ends the inspection.

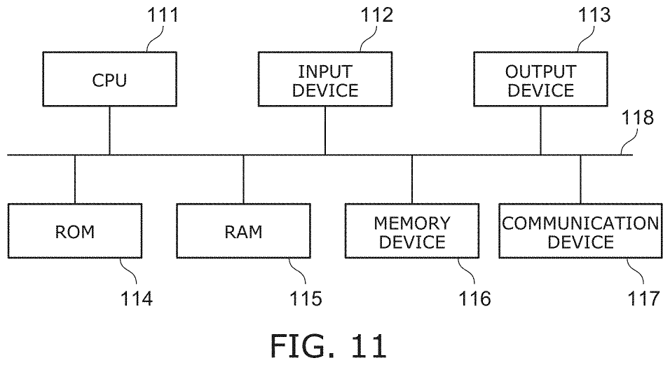

FIG. 11 is a schematic view illustrating a hardware configuration of the inspection device according to the embodiment.

The inspection device described above includes a central processing unit (CPU) 111, an input device 112, an output device 113, ROM (Read Only Memory) 114, RAM (Random Access Memory) 115, a memory device 116, a communication device 117, and a bus 118. The components are connected by the bus 118.

The CPU 111 includes a processing circuit. The CPU 111 performs various processing in collaboration with various programs prestored in the ROM 114 or the memory device 116 and comprehensively controls the operations of the inspection device 10. The function as the processor 13 of the inspection device described above is realized thereby. In the processing, the CPU 111 uses a prescribed region of the RAM 115 as a work region. The CPU 111 realizes the input device 112, the output device 113, the communication device 117, etc., in collaboration with programs prestored in the ROM 114 or the memory device 116.

The input device 112 includes, for example, a keyboard, a mouse, or a touch panel. The input device 112 accepts information input from the user as instruction signals and outputs the instruction signals to the CPU 111. The output device 113 is, for example, a monitor. The output device 113 visibly outputs various information based on signals output from the CPU 111.

The ROM 114 non-rewritably stores programs used to control the inspection device 10, various setting information, etc. The RAM 115 is a volatile storage medium such as SDRAM (Synchronous Dynamic Random Access Memory), etc. The RAM 115 functions as a work region of the CPU 111. Specifically, the RAM 115 functions as a buffer temporarily storing various variables, parameters, and the like used by the inspection device 10, etc.

The memory device 116 is a rewritable recording device such as a semiconductor storage medium such as flash memory or the like, a magnetically or optically recordable storage medium, etc. The memory device 116 stores programs used to control the inspection device 10, various setting information, etc. The communication device 117 is used to transmit and receive information by communicating with external devices.

### Second Embodiment

The laser output of a welding device that performs laser welding can be controlled by feeding back the inspection results of the inspection device described above.

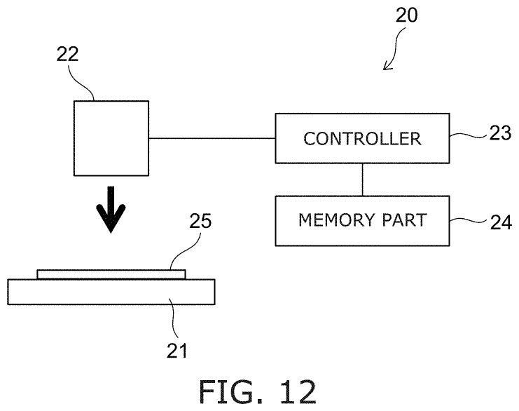

FIG. 12 is a schematic view illustrating the welding device according to the embodiment. As shown in FIG. 12, the welding device 20 includes a laser outputter 22 that irradiates a laser on a welding object 25 placed on a stage 21, a controller 23 that controls the laser outputter 22, and a memory part 24. The controller 23 calculates the output of the laser outputter 22 and the calibration amount for correcting the output.

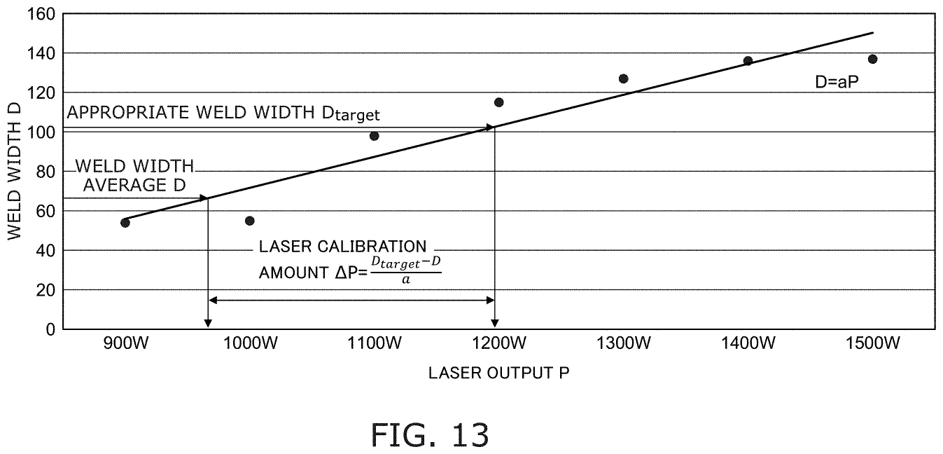

FIG. 13 is a graph showing a calibration curve of an example of the relationship between the weld width and the laser output of the welding device 20. The welding device 20 pre-stores the calibration curve in the memory part 24, etc., and welds using a laser output based on the calibration curve.

As shown in FIG. 13, the calibration curve is represented by D=aP. D is the weld width, P is the laser output, and a is a constant.

The laser calibration amount can be determined as follows. First, the average weld width D that is the average value of the widths d of the multiple weld areas included in the inspection object M obtained by the inspection device 10 is calculated. A laser calibration amount ΔP is calculated from the difference between an appropriate weld width D_{target} and the average weld width D.

The calculation of the laser calibration amount may be performed by the inspection device 10.

Thus, according to the embodiment, data of at least two images of the weld zone to be inspected is imaged using different imaging conditions; and the inner and outer contour lines of the weld area are measured by selectively using images suited to the contour lines of the weld area. Thus, because the measurement of the width of the weld area is performed based on the measured contour lines of the weld area, the width of the weld area can be measured with high accuracy, and the weld state can be accurately inspected. The laser output when welding can be calibrated to an appropriate value based on the width of the weld area that is measured with high accuracy.

According to the embodiments described above, the weld state of the weld zone can be accurately inspected, and the parameters when welding can be corrected.

Hereinabove, embodiments of the invention are described with reference to specific examples. However, the invention is not limited to these specific examples. For example, one skilled in the art may similarly practice the invention by appropriately selecting specific configurations of components included in the inspection device from known art; such practice is within the scope of the invention to the extent that similar effects can be obtained.

Combinations of any two or more components of the specific examples within the extent of technical feasibility also is within the scope of the invention to the extent that the spirit of the invention is included.

Also, all inspection devices practicable by an appropriate design modification by one skilled in the art based on the inspection devices described above as embodiments of the invention also are within the scope of the invention to the extent that the spirit of the invention is included.

Furthermore, various modifications and alterations within the spirit of the invention will be readily apparent to those skilled in the art; and all such modifications and alterations also should be seen as being within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An inspection device, comprising:
an imager acquiring first image data and second image data, the first image data being of a first weld zone imaged using a first condition, the second image data being of the first weld zone imaged using a second condition different from the first condition, the first weld zone including
a first non-weld area,
a second non-weld area, and
a first weld area between the first non-weld area and the second non-weld area; and
a processor performing at least a first inspection of the first weld zone based on
a result of detecting a first boundary between the first non-weld area and the first weld area based on the first image data, and
a result of detecting a second boundary between the first weld area and the second non-weld area based on the second image data.

2. The device according to claim 1, wherein
the first weld area is at an outer side of the first non-weld area, and
the second non-weld area is at an outer side of the first weld area.

3. The device according to claim 1, wherein
the first condition and the second condition are exposure times when imaging with the imager, and
the exposure time of the first condition is less than the exposure time of the second condition.

4. The device according to claim 1, wherein
the first condition and the second condition are illuminances of the first weld zone when imaging with the imager, and
the illuminance of the first condition is less than the illuminance of the second condition.

5. The device according to claim 1, wherein
the first non-weld area is smaller than the second non-weld area.

6. The device according to claim 1, wherein
the processor further performs a second inspection of the first weld zone based on at least one of
a first distribution of luminances of pixels corresponding to the first weld area in the first image data, or
a second distribution of luminances of pixels corresponding to the first weld area in the second image data.

7. The device according to claim 6, wherein
the processor calculates a size of the first weld area based on at least one of the first distribution or the second distribution and evaluates the first weld area to be an unwelded area in the case where the size is not more than a first threshold.

8. The device according to claim 1, wherein
the processor calculates a width of the first weld area based on the first and second boundaries.

9. The device according to claim 8, wherein
the processor evaluates the first weld area to be a welding defect in the case where the width is outside a determined range of values.

10. The device according to claim 1, wherein
the imager acquires third image data and fourth image data, the third image data being of a second weld zone imaged using a third condition, the fourth image data being of the second weld zone imaged using a fourth condition different from the third condition,
the second weld zone includes:
a third non-weld area;
a fourth non-weld area; and
a second weld area located between the third non-weld area and the fourth non-weld area,
the processor inspects the second weld zone based on:
a result of detecting a third boundary between the third non-weld area and the second weld area based on the third image data; and
a result of detecting a fourth boundary between the second weld area and the fourth non-weld area based on the fourth image data, and
at least one of the third condition or the fourth condition is different from the first condition and different from the second condition.

11. The device according to claim 10, wherein
the first weld zone and the second weld zone are included in an inspection object, and
a position of the first weld zone in the inspection object is different from a position of the second weld zone in the inspection object.

12. A welding device, comprising:
a laser outputter irradiating a laser on a welding object; and
a controller controlling the laser outputter,
the controller controlling an output of the laser based on information obtained from a first boundary and a second boundary,
the first boundary being detected based on first image data of a first weld zone imaged using a first condition,
the second boundary being detected based on second image data of the first weld zone imaged using a second condition different from the first condition,
the first weld zone including
a first non-weld area,
a second non-weld area, and
a first weld area located between the first non-weld area and the second non-weld area,
the first boundary being between the first non-weld area and the first weld area,
the second boundary being between the first weld area and the second non-weld area.
